(19) United States
(12) Patent Application Publication
(10) Pub. No.: US 2026/0268474 A1
(43) Pub. Date: Sep. 10, 2026

(54) SYNTHETIC IMAGE GENERATION FOR SOLDER JOINT INSPECTION

(71) Applicant: Raytheon Company, Arlington, VA (US)

(72) Inventors: Brigid A. Blakeslee, Oradell, NJ (US); Daniel P. Macko, Victor, NY (US); Jose Miguel Pasini, Simsbury, CT (US); Jeffrey A. Shubrooks, South Boston, MA (US); Michael R. Oravec, PLYMOUTH, MA (US); Justin V. Farrell, Stratham, NH (US); Richard W. Osborne, Stafford Springs, CT (US)

(21) Appl. No.: 19/075,488

(22) Filed: Mar. 10, 2025

(51) Int. Cl. G06T 7/00

(52) U.S. Cl. CPC G06T 7/001; G06T 2207/10116; G06T 2207/20084; G06T 2207/30141; G06T 2207/30152

(57) ABSTRACT

Systems, devices, methods, and computer-readable media for circuit board quality analysis are provided. A method can include receiving, by a trained generative adversarial network (GAN) generator and during a circuit board population process, an image, generating, by the trained GAN generator, a synthetic x-ray image, the synthetic x-ray image is a prediction of a real x-ray image that will be generated by an x-ray inspection later in the circuit board population process, determining, based on the synthetic x-ray image, whether the circuit board will pass or fail the circuit board population process, and scrapping the circuit board or adjusting a parameter of the circuit board population process responsive to determining the circuit board will fail.

### TECHNICAL FIELD

Aspects regard defect detection in circuit boards. Machine learning (ML) can be leveraged to help identify defects in a circuit board earlier in the circuit board generation process than was possible before.

### BACKGROUND

Inspection of solder joints is a critical functionality to detect voids, shorts, or the like in a circuit board. Current processes perform solder joint inspection after an x-ray of the circuit board is generated at the end of a manufacturing process. The solder joint inspection informs whether the circuit board is of sufficient fidelity to function as expected.

### BRIEF DESCRIPTION OF DRAWINGS

FIG. 1 illustrates, by way of example, a diagram of an embodiment of a system for circuit board population.

FIG. 2 illustrates, by way of example, a diagram of an embodiment of a system that can predict x-ray inspection failures without requiring operation of an actual x-ray inspection.

FIG. 3 illustrates, by way of example, a diagram of an embodiment of a process for adjusting a stencil for board population.

FIG. 4 illustrates, by way of example, a diagram of an embodiment of a process for GAN generator training.

FIG. 5 illustrates, by way of example, a diagram of an embodiment of a method for improved circuit board generation.

FIG. 6 is a block diagram of an example of an environment including a system for neural network (NN) training.

FIG. 7 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

An issue with determining board fidelity based on an x-ray, is that the x-ray is generated at the end of the board populating process. By judging the fidelity of the circuit board at the end of the board population process, excess waste is created in terms of wasted components, wasted energy used in generating the circuit board, wasted time that could be used to generate a board that functions properly, among other excess waste. The board population process places solder paste in a predefined pattern, then places circuit components to the board and reflows the solder to attach the components to the board. The board population process includes inspecting solder joints after the solder paste placement and before the circuit components are added to the circuit board. The solder inspection images captured early in the manufacturing process, data regarding process parameters, machine configurations, solder paste lot details, among other possible details, can further inform inspection decisions or support mitigation of the propagation of defects earlier in the circuit board population process than the x-ray image inspection, such as before reflow. The defects can be detected earlier, so that further downstream activity on the circuit board can be halted and not wasted. The components of the circuit board can be saved for a board that has better solder fidelity, the components can be recovered for a board with better solder paste fidelity and a board with bad fidelity can be detected that might otherwise pass solder paste inspection though fail x-ray inspection.

Some embodiments can perform fidelity inspection earlier in the board production process than the x-ray image inspection. Some embodiments can leverage a trained generative adversarial network (GAN) to predict the x-ray image based on a solder image. Since the solder image is generated much earlier in the board population process, the predicted x-ray image can be generated much earlier in the board generation process than is typical. X-ray image inspection can then be performed earlier in the process and inform whether any changes can be made to the circuit board generation process (e.g., different components, different process parameters, or the like) to generate a board with sufficient fidelity or if the board can be scrapped before the board is populated. Either way, time, energy, and process bandwidth are saved for boards that are more likely to pass fidelity checks using the GAN and earlier predicted (sometimes called “synthetic”) x-ray image inspection.

Some embodiments can support design of a deposit stencil, board layout, or the like. The deposit stencil design, board layout, or the like, can be used, along with a solder image, process parameters, or the like, as input to a GAN. The GAN can generate a predicted x-ray image. The predicted x-ray image can inform design changes to the deposit stencil or the board layout. The design of the solder mask or board layout can be adjusted to account for any predicted recurring defects shown in the x-ray image.

In addition to solder paste inspection (SPI) images captured early in the manufacturing process, data regarding process parameters, machine configurations, solder paste lot details, etc., could further inform inspection decisions or support mitigation of the propagation of defects.

Reference will now be made to the FIGS. to describe further details of embodiments.

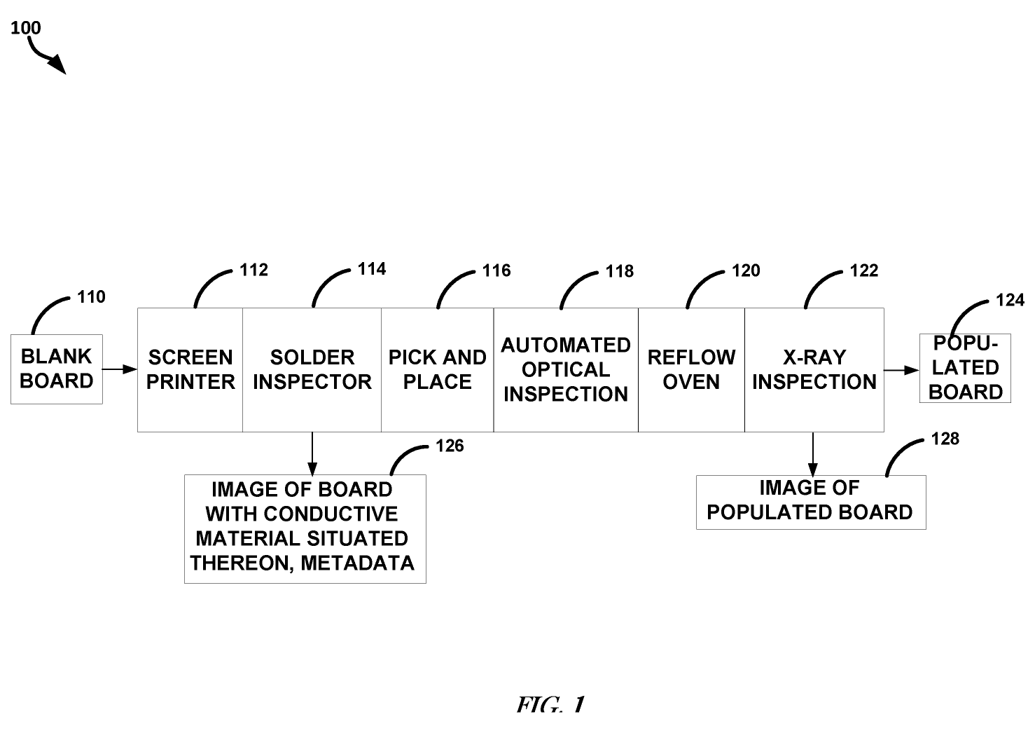

FIG. 1 illustrates, by way of example, a diagram of an embodiment of a system 100 for circuit board population. The system 100 takes a blank circuit board 110 as input and generates a populated circuit board 124 as output. The system 100 as illustrated includes a screen printer 112, a solder inspector 114, a pick and place 116, an automated optical inspection (AOI) 118, a reflow oven 120, and an x-ray inspection 122. The blank board 110 can include traces, pads, vias, or the like formed thereon. The blank board 110 can be single-sided, double-sided, multi-layer, or the like. A substrate of the blank board 110 can be made from FR-4, polyimide, polytetrafluoroethylene (PTFE), polyester, or the like.

The blank board 110 can be screen printed by a screen printer 112. The screen printer 112 deposits conductive material on blank board 110. The screen printer uses a stencil that defines where to deposit the conductive material onto the surface of the blank board 110. The conductive material is deposited at the pads to which the electric/electronic components are to be placed by a pick-and-place device 116. The stencil is made from a thin, flat sheet of material, such as polyester or stainless steel, that has a pattern of openings cut into it. The conductive material is then forced through the stencil and onto the blank board 110, such as by using a squeegee, which spreads the conductive material over the portions of the surface of the circuit board 110 that are exposed by the stencil.

The board 110 now has conductive material thereon. Solder inspection is then performed by a solder inspector 114. The solder inspection is sometimes referred to as solder paste inspection (SPI). The solder inspector 114 generates one or more images 126 of the board with conductive material situated thereon. The image 126 is an optical image, such as a three-dimensional image, of the board 110 with conductive material thereon. The solder inspector 114 measures the height, volume, area, and shape of the conductive material based on the image(s). The solder inspector 114 can provide the measurements as metadata, along with the image 126. The solder inspector 114 further detects defects like scratches, stains, nodules, misalignment, or the like. The defects can also be provided as metadata, along with the image.

The pick and place 116 grabs electric/electronic components and situates the electric/electronic components on the conductive material on the board 110. The pick and place 116 uses a robotic arm or similar mechanism with specialized tools (like vacuum nozzles) to pick up items from a source and precisely place them at a designated location. The pick and place often incorporates a vision system to identify and locate electric/electronic components before picking them up, ensuring proper placement.

The automated optical inspection (AOI) 118 uses cameras and image processing to inspect the circuit board for defects, after the board is populated using the pick and place 116. The AOI 118 generates images of the board and compares the images to expected standards to identify defects and automatically reports results of the comparison. The AOI 118 can detect defects at the part level, such as location or position polarity. The defects can be caused by the pick and place 116 or otherwise in the manufacturing of the board 110.

The reflow oven 120 is a machine that uses heat to electrically and mechanically connect electronic components of the board 110 to conductive elements of the board 110. The process of using a reflow oven is called reflow soldering. The conductive material is applied to the PCB pads, by the screen printer 112, using a stencil. The pick and place 116 situates electric/electronic components on the conductive material. The board 110 is placed in the reflow oven 120. The oven 120 heats the board 110 and the conductive material to a temperature above the melting point of the conductive material. The conductive material “reflows” onto the terminals of the electric/electronic components. The board 110 and the corresponding conductive material then cools and hardens as it cools forming an electrical and mechanical connection between the terminals of the components and the pads on the board 110.

The x-ray inspection 122 produces an x-ray image 128 of the populated board. The x-ray image 128 shows the internal structure of the board 110. The x-ray inspection 122 produces x-rays that penetrate the board 110. The x-rays pass through different materials with varying atomic weights and elemental compositions. The x-rays are differentially absorbed by the materials, with heavier elements appearing darker and lighter elements appearing more transparent in the image 128. The x-ray inspection 122 analyzes, either automated inspection, human inspection, or a combination thereof, the image 128 to identify defects. The x-ray inspection 122 can detect a variety of defects, including soldering faults, voiding, bridging, component misalignments, layer misalignment, broken traces, broken vias, or the like.

The populated board 124 includes the components electrically and mechanically connected to pads thereof. The populated board 124 has passed inspection by the solder inspector 114, the AOI 118, and the x-ray inspection 122 and has sufficient fidelity for a customer. There are many instances, however, where the board 110 can go through the system 100, pass both the solder inspector 114, and the AOI 118, but fail at the x-ray inspection 122. It would be beneficial to reduce the rate of failure at the x-ray inspection 122 and predict failures before they occur at the x-ray inspection 122. This would save time, money, and resources in the process of populating the circuit board 110.

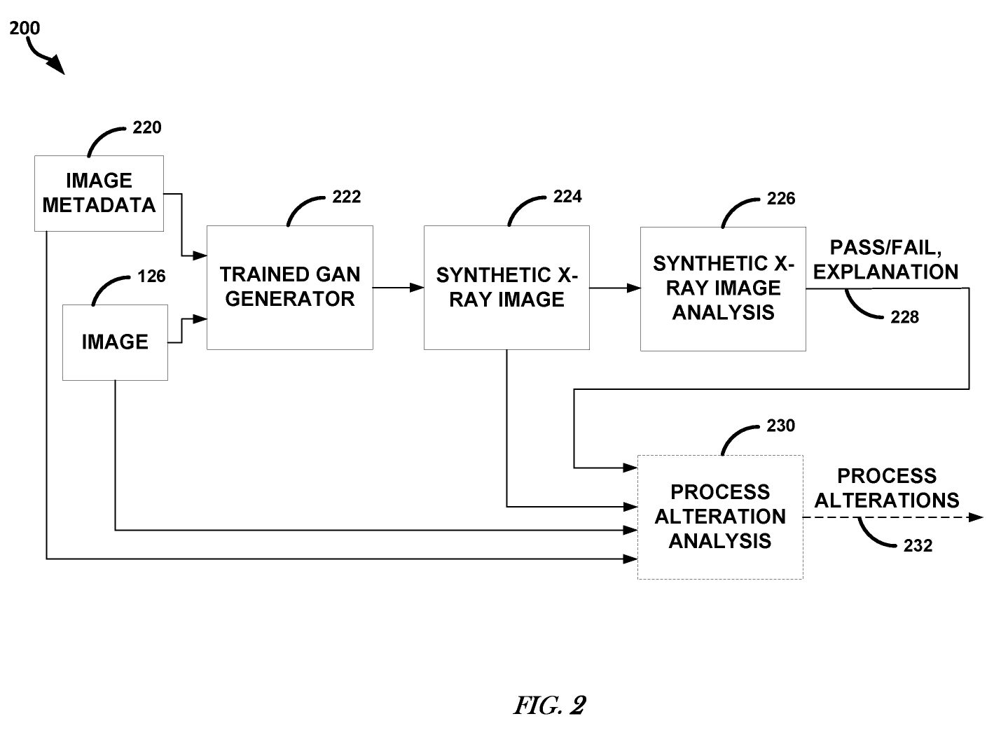

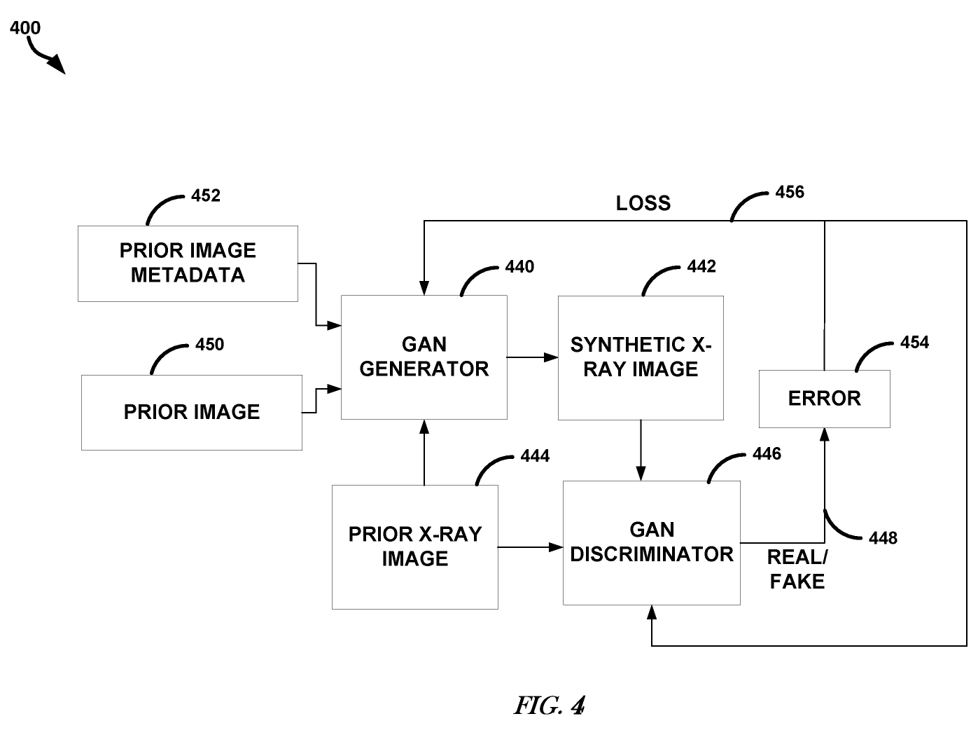

FIG. 2 illustrates, by way of example, a diagram of an embodiment of a system 200 that can predict x-ray inspection failures without requiring operation of the x-ray inspection 122. The system 200 as illustrated includes a trained generative adversarial network (GAN) generator 222 that has been trained to generate a synthetic x-ray image 224 based on the image 126 generated by the solder inspector 114. More details regarding the training of the GAN generator 222 are provided regarding FIG. 4. The synthetic x-ray image 224 can be generated after the solder inspector 114 generates the image 126 and before the board 110 is provided to the pick and place 116. The system 100 can produce a reliable prediction 228 as to whether the board 110 will pass or fail fidelity requirements based on the image 126. The prediction 228 of pass/fail can inform whether the board is scrapped, the process of populating the board 110 is altered, or the board 110 continues to be processed using the process as it is currently configured.

The system 200 as illustrated includes the image 126 provided as input to the trained GAN generator 222. The system 200 also includes optional image metadata 220. The image 126 is the image produced by the solder inspector 114. The image metadata 220 can include output from the solder inspector 114, process data associated with the board 110 that is in the image 126, or a combination thereof. The output from the solder inspector 114 can indicate the height, volume, area, and shape of the conductive material, defects like scratches, stains, nodules, misalignment, or the like, or a combination thereof. The process data can indicate a type of conductive material used by the screen printer 112, a source of the conductive material, a lot number of the board 110, machine settings of the screen printer 112 or other machine in the system 100.

The trained GAN generator 222 generates a synthetic x-ray image 224 based on the input. The synthetic x-ray image 224 is a predication of the image 128 that would be produced by the x-ray inspection 122 if the board associated with the input was to go through the pick and place 116, AOI 118, reflow oven 120, and x-ray inspection 122.

At operation 226, synthetic x-ray image analysis is performed on the synthetic x-ray image 224. The operation 226 can perform the same analysis as the x-ray inspection 122 performs on the x-ray image 128. The synthetic x-ray image 224 is produced, and the analysis operation 226 is performed, much earlier in the process than the actual x-ray image 128 and analysis performed by the x-ray inspection 122. Any issues that might be revealed by analyzing the x-ray image 128 can be realized earlier in the process by analyzing the synthetic x-ray image 224. Some issues, like a void, misalignment, or the like, can even be resolved by adjusting one or more parameters of the board population process 100. Thus, instead of scrapping a board that would otherwise be scrapped, a board that is analyzed using the trained GAN generator 222 can be saved based on insights from the synthetic x-ray image 224. Further, if a board is not salvageable through a process adjustment, it can be scrapped before performing pick and place 116 and further downstream processes. The synthetic x-ray image analysis operation 226 saves components and board population process bandwidth for boards that have a higher likelihood of having sufficient fidelity.

The operation 226 produces a pass/fail output 228 and optionally provides an explanation. In some embodiments, the process 200 can end with the operation 226 providing the output 228 of pass/fail. The board can be scrapped if the output 228 indicates fail.

In other embodiments, if the board fails, the explanation can inform whether the board is salvageable by a process parameter adjustment. The process parameter(s) to be adjusted can be determined by a process alteration analysis operation 230. The operation 230 can be performed by an ML model, a heuristic model, or a combination thereof. The ML model can include a decision tree, an object detection model, an object classification model or the like. The decision tree can include a random forest, boosted tree, or the like. The heuristic model can perform edge detection, corner detection, segmentation, or a combination thereof to identify potential defects. The ML model, heuristic model, or a combination thereof can perform feature characterization, analysis/assessment, or metrics (e.g., measuring anticipated defects in synthetic x-ray images or observed features in solder images, etc.). A void of one size can warrant a change in reflow temperature of a specified number of degrees, and a void of a different size can warrant a change in reflow temperature of a different specified number of degrees. This supports measurement/characterization of the object or feature that was detected.

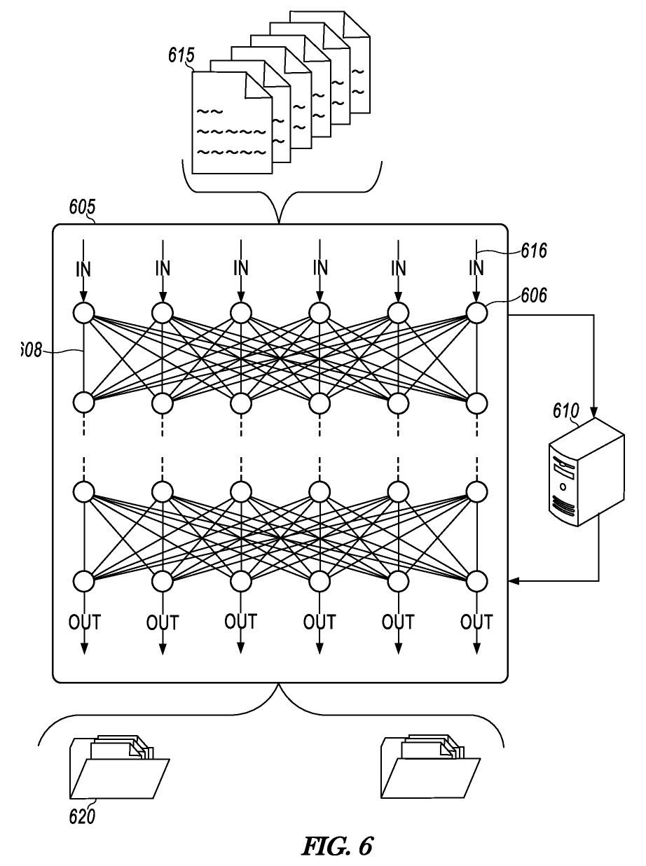

The operation 230 indicates an adjustment 232 to the process that can cause the board that would otherwise fail the x-ray inspection 122 to pass the x-ray inspection 122. The ML model of the operation 230 can be trained based on similar input data as the trained GAN generator 222. More details regarding the training are provided regarding FIGS. 4 and 6.

The synthetic x-ray image 224 and the analysis operation 226 allows for improved board throughput and reduces time wasted operating the system 100. The board throughput is increased by altering the process to produce the populated board 124 with sufficient fidelity. The time wasted is reduced because a board that would fail fidelity regardless of whether the process is adjusted is scrapped without performing pick and place 116 or other downstream processes.

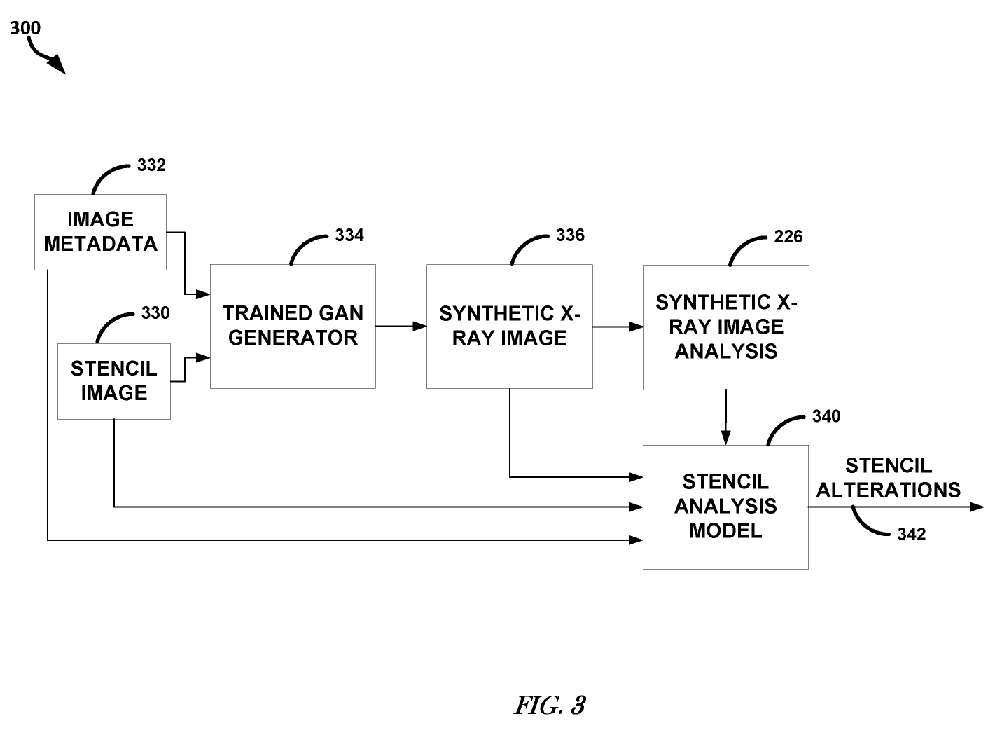

FIG. 3 illustrates, by way of example, a diagram of an embodiment of a process 300 for adjusting a stencil for board population. The stencil is a part that is used in the screen printer 112. The stencil determines where conductive material is situated on the board, such as on pads or other interconnect structures on the board 110. Not only can a synthetic x-ray image generated by the trained GAN generator 334 be used to predict whether a board will pass or fail earlier in the board population process, it can also be used to identify alterations 342 to a stencil that improves the throughput of the board population process.

The process 300 includes providing a stencil image 330 and optional stencil image metadata 332 to the trained GAN generator 334. The stencil image 330 can be an optical image or other type of image, such as a vector-based image. The image metadata 332 can be similar to the image metadata 220. The image metadata 332 can include the image 126 generated by the solder inspector 114 after screen printing the board 110 using the stencil in the image 330 and the screen printer 112.

The trained GAN generator 334 generates a synthetic x-ray image 336 that is a prediction of the result that would be produced if the board 110 went all the way through the process 100. The trained GAN generator 334 can be trained similar to the trained GAN generator 222, but the trained GAN generator 334 can include the stencil image 330 as input.

The synthetic x-ray image 336 can be analyzed by the operation 226. The output of the operation 226 can be provided to a stencil analysis model 340. The stencil analysis model 340 can be similar to the model used to perform the operation 230. The stencil analysis model 340 can take, as input, the synthetic x-ray image 336, the stencil image 330, the image metadata 332, or a combination thereof. The stencil analysis model 340 can include an ML model, such as a decision tree, an object detection model, an object classification model, heuristic model, a combination thereof, or the like. The decision tree can include a random forest, boosted tree, or the like. The stencil analysis model 340 indicates an adjustment to the stencil in the stencil image 330 that can cause the board that would otherwise fail the x-ray inspection 122 to pass the x-ray inspection 122. The ML model 340 can be trained based on similar input data as the process alteration analysis operation 230. More details regarding the training are provided regarding FIGS. 4 and 6.

FIG. 4 illustrates, by way of example, a diagram of an embodiment of a process 400 for GAN generator 440 training. The process 400 as illustrated includes receiving, as input and at the GAN generator 440, a prior image 450, prior image metadata 452, or a combination thereof. The prior image 450 can include images 126 generated by the solder inspector 114, a prior stencil image, or the like. The GAN generator 440 can thus be trained to generate a synthetic x-ray image 442 based on an image after conductive material deposit, an image of the stencil, or a combination thereof. If the purpose of the GAN generator 440 is for use in predicting board failure or a process parameter adjustment, the image 450 can be prior instances of the image 126. If the purpose of the GAN generator 440 is for use in predicting changes to a stencil, the image 450 can be prior instances of the stencil image 330.

The prior image metadata 452 can include the same data as the image metadata 220, 332, or the like, but associated with a prior population of the board 110. The prior image metadata 452 can include the same data that is to be used during inference with the trained GAN generator 222, 334.

The GAN generator 440 can receive a prior x-ray image 444. The prior x-ray image is associated with the population of the same board 110 associated with the prior image 450 as input. The GAN generator 440 can generate a synthetic x-ray image 442 based on the input. A goal of the GAN generator 440 is to produce a synthetic x-ray image 442 that is indistinguishable, to the GAN discriminator 446, from the prior x-ray image 444.

The GAN discriminator 446 receives the prior x-ray image 444 and the synthetic x-ray image 442. The GAN discriminator produces output 448 indicating whether the synthetic x-ray image 442 is real or fake and whether the prior x-ray image 444 is real or fake. The GAN discriminator 446 and the GAN generator 440 can be updated based on error (loss 456) determined by an error operator 454. An update of the GAN discriminator 446 can be to better distinguish between the prior x-ray image 444 and the synthetic x-ray image 442. An update of the GAN generator 440 can be to improve the synthetic x-ray image 442 so that the GAN discriminator 446 mistakes the synthetic x-ray image 442 for the prior x-ray image 444.

Example loss functions used by the error operator 454 include a binary cross-entropy loss, Earth mover’s distance, least squares, conditional loss, or the like. Both the GAN generator 440 and the GAN discriminator 446 have their own loss functions and their own respective loss 456. The GAN generator 440 aiming to minimize its loss by creating realistic data, while the GAN discriminator 446 aims to maximize its loss by accurately distinguishing real from generated data. After training, the GAN generator 440 becomes the trained GAN generator 222, 334.

The ML model of operation 230 and the model 340 can be trained using similar input as the GAN generator 440. The error operator 454 for a decision tree can use a loss function that considers a Gini impurity, entropy, classification error, or the like. The primary goal of a tree loss function is to guide the decision tree model in selecting the best split at each node by maximizing the "purity" of the resulting child nodes.

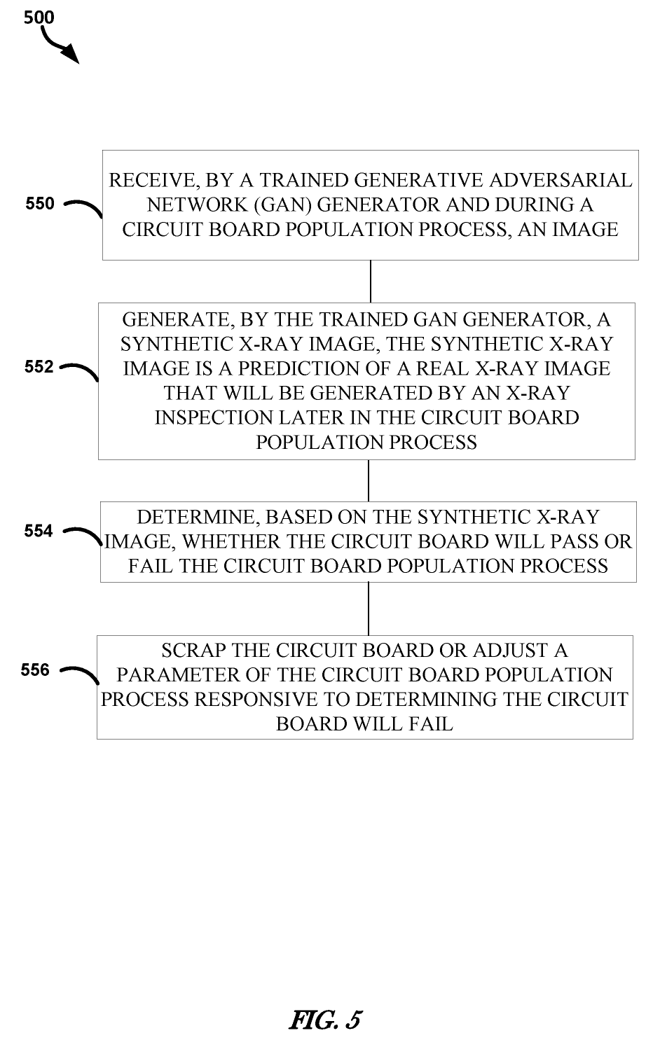

FIG. 5 illustrates, by way of example, a diagram of an embodiment of a method 500 for improved circuit board quality analysis. The method 500 as illustrated includes receiving, by a trained generative adversarial network (GAN) generator and during a circuit board population process, an image, at operation 550; generating, by the trained GAN generator, a synthetic x-ray image, the synthetic x-ray image is a prediction of a real x-ray image that will be generated by an x-ray inspection later in the circuit board population process, at operation 552; determining, based on the synthetic x-ray image, whether the circuit board will pass or fail the circuit board population process, at operation 554; and scrapping the circuit board or adjusting a parameter of the circuit board population process responsive to determining the circuit board will fail, at operation 556.

The image can be generated by a solder inspector after conductive material is situated on the circuit board by a screen printer. The image can include a view of the circuit board with the conductive material situated thereon. The operation 554 can occur before the circuit board is provided to a pick and place of the circuit board population process. The image can be of a stencil used in situating conductive material on the circuit board and by a screen printer.

The adjustment to the parameter of the circuit board population process can include an alteration to the stencil. The method 500 can further include receiving, with the image, image metadata. The image metadata can include height of conductive material, volume of the conductive material, area covered by the conductive material, shape of the conductive material, a defect in the conductive material, a type of the conductive material, a source (e.g., material, lot number, manufacturer, or the like) of the conductive material, a lot number of the circuit board, or machine settings of a screen printer or other machine used in the circuit board population process. Determining the parameter to adjust can be performed using a machine learning (ML) model. The ML model can be a trained decision tree model, an object detection model, object classification model, feature detection model, heuristic model, a combination thereof, or the like.

What follows is a general description of Artificial Intelligence (AI) and AI model training. AI is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The trained GAN generator 222, operator 230, trained GAN generator 334, model 340, GAN generator 440, GAN discriminator 446, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. In some examples, if the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN’s result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent (e.g., a stochastic gradient descent) technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

FIG. 6 is a block diagram of an example of an environment including a system for neural network (NN) training. The system includes an artificial NN (ANN) 605 that is trained using a processing node 610. The processing node 610 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 605, or even different nodes 606 within layers. Thus, a set of processing nodes is arranged to perform the training of the ANN 605. The trained GAN generator 222, operator 230, trained GAN generator 334, model 340, GAN generator 440, GAN discriminator 446, another component, or a component thereof can be trained using the system of FIG. 6.

The set of processing nodes is arranged to receive a training set 615 for the ANN 605. The ANN 605 comprises a set of nodes 606 arranged in layers (illustrated as rows of nodes 606) and a set of inter-node weights 608 (e.g., parameters) between nodes in the set of nodes. In an example, the training set 615 is a subset of a complete training set. Here, the subset may enable processing nodes with limited storage resources to participate in training the ANN 605.

The training data may include multiple numerical values representative of a domain, such as an image feature, or the like. Each value of the training or input 616 to be classified after ANN 605 is trained, is provided to a corresponding node 606 in the first layer or input layer of ANN 605. The values propagate through the layers and are changed by the objective function.

As noted, the set of processing nodes is arranged to train the neural network to create a trained neural network. After the ANN is trained, data input into the ANN will produce valid classifications 620 (e.g., the input data 616 will be assigned into categories), for example. The training performed by the set of processing nodes 606 is iterative. In an example, each iteration of the training the ANN 605 is performed independently between layers of the ANN 605. Thus, two distinct layers may be processed in parallel by different members of the set of processing nodes. In an example, different layers of the ANN 605 are trained on different hardware. The different members of the set of processing nodes may be located in different packages, housings, computers, cloud-based resources, etc. In an example, each iteration of the training is performed independently between nodes in the set of nodes. This example is an additional parallelization whereby individual nodes 606 (e.g., neurons) are trained independently. In an example, the nodes are trained on different hardware.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term "hardware-implemented module" should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a "cloud computing" environment or as a "software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### ELECTRONIC APPARATUS AND SYSTEM

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### EXAMPLE MACHINE ARCHITECTURE AND MACHINE-READABLE MEDIUM E.G. STORAGE DEVICE

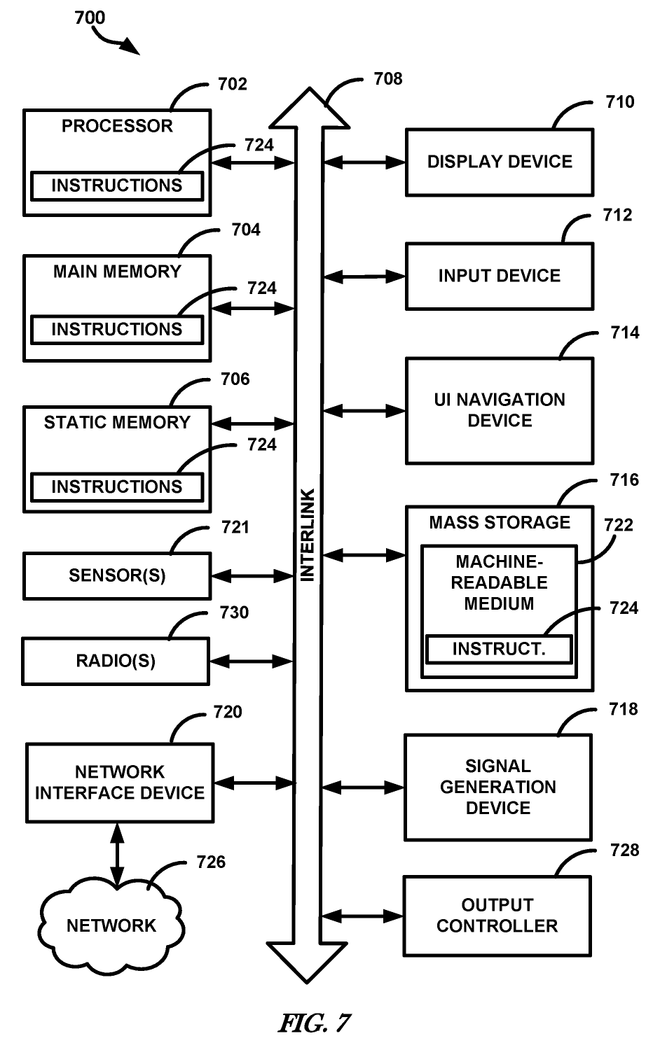

FIG. 7 illustrates, by way of example, a block diagram of an embodiment of a machine in the example form of a computer system 700 within which instructions, for causing the machine to perform any one or more of the methodologies discussed herein, may be executed. One or more of the screen printer 112, solder inspector 114, pick and place 116, AOI 118, reflow oven 120, x-ray inspection 122, trained GAN generator 222, operator 226, operator 230, trained GAN generator 334, model 340, GAN generator 440, GAN discriminator 446, error operator 454, method 500, or a component thereof can be implemented using, or can include the system 700 or a component thereof. One or more of the, screen printer 112, solder inspector 114, pick and place 116, AOI 118, reflow oven 120, x-ray inspection 122, trained GAN generator 222, operator 226, operator 230, trained GAN generator 334, model 340, GAN generator 440, GAN discriminator 446, error operator 454, method 500, or a component or operation thereof can be implemented or performed by the computer system 700. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 721 (e.g., a transducer that converts one form of energy (e.g., light, heat, electrical, mechanical, or other energy) to another form of energy), such as an IR, x-ray, SAR, SAS, visible, or other image sensor, or the like, or a combination thereof), or the like, or a combination thereof, a main memory 704 and a static memory 706, which communicate with each other via a bus 708. The memory 704, 706 can store parameters (sometimes called weights) that define operations of the processing circuitry (e.g., the processor 702), an NN component, or other component of the system 700. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker), a network interface device 720, and radios 730 such as Bluetooth, WWAN, WLAN, and NFC, permitting the application of security controls on such protocols. Note that a space vehicle does not typically include a display, UI navigation device, or the like.

The machine 700 as illustrated includes an output controller 728. The output controller 728 manages data flow to/from the machine 700. The output controller 728 is sometimes called a device controller, with software that directly interacts with the output controller 728 being called a device driver.

### MACHINE-READABLE MEDIUM

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704, the static memory 706, and/or within the processor 702 during execution thereof by the computer system 700, the main memory 704 and the processor 702 also constituting machine-readable media.

While the machine-readable medium 722 is shown in an example embodiment to be a single medium, the term "machine-readable medium" may include a single medium or multiple media (e.g., a centralized or distributed database, and/or associated caches and servers) that store the one or more instructions or data structures. The term "machine-readable medium" shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term "machine-readable medium" shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### TRANSMISSION MEDIUM

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term "transmission medium" shall be taken to include any intangible medium that is capable of storing, encoding, or carrying instructions for execution by the machine, and includes digital or analog communications signals or other intangible media to facilitate communication of such software.

### Additional Example

Example 1 includes a method comprising receiving, by a trained generative adversarial network (GAN) generator and during a circuit board population process, an image, generating, by the trained GAN generator, a synthetic x-ray image, the synthetic x-ray image is a prediction of a real x-ray image that will be generated by an x-ray inspection later in the circuit board population process, determining, based on the synthetic x-ray image, whether the circuit board will pass or fail the circuit board population process, and scrapping the circuit board or adjusting a parameter of the circuit board population process responsive to determining the circuit board will fail.

In Example 2, Example 1 further includes, wherein the image is generated by a solder inspector after conductive material is situated on the circuit board by a screen printer, and the image includes a view of the circuit board with the conductive material situated thereon.

In Example 3, Example 2 further includes, wherein the determination of whether the circuit board will pass or fail occurs before the circuit board is provided to a pick and place of the circuit board population process.

In Example 4, at least one of Examples 1-3 further includes, wherein the image is of a stencil used in situating conductive material on the circuit board and by a screen printer.

In Example 5, Example 4 further includes, wherein the adjustment to the parameter of the circuit board population process includes an alteration to the stencil.

In Example 6, at least one of Examples 1-5 further includes receiving, with the image, image metadata, the image metadata including height of conductive material, volume of the conductive material, area covered by the conductive material, shape of the conductive material, a defect in the conductive material, a type of the conductive material, a source of the conductive material, a lot number of the circuit board, or machine settings of a screen printer or other machine used in the circuit board population process.

In Example 7, at least one of Examples 1-6 further includes, wherein the method includes scrapping the circuit board.

In Example 8, at least one of Examples 1-7 further includes, wherein the method includes adjusting a parameter of the circuit board population process responsive to determining the circuit will fail.

In Example 9, Example 8 further includes determining the parameter to adjust using a machine learning (ML) model.

In Example 10, Example 9 further includes, wherein the ML model is a trained decision tree model, object classification model, object detection model, feature classification model, or the like.

Example 11 includes a system comprising a trained generative adversarial network (GAN) generator configured to receive, during a circuit board population process, an image, and generate a synthetic x-ray image, the synthetic x-ray image is a prediction of a real x-ray image that will be generated by an x-ray inspection later in the circuit board population process, and processing circuitry configured to determine, based on the synthetic x-ray image, whether the circuit board will pass or fail the circuit board population process, and cause the circuit board to be scrapped or adjust a parameter of the circuit board population process responsive to determining the circuit board will fail.

In Example 12, Example 11 further includes a solder inspector configured to generate the image after conductive material is situated on the circuit board by a screen printer, and wherein the image includes a view of the circuit board with the conductive material situated thereon.

In Example 13, Example 12 further includes a pick and place device, and wherein the determination of whether the circuit board will pass or fail occurs before the circuit board is provided to a pick and place of the circuit board population process.

In Example 14, at least one of Examples 11-13 further includes, wherein the image is of a stencil used in situating conductive material on the circuit board and by a screen printer.

In Example 15, Example 14 further includes, wherein the adjustment to the parameter of the circuit board population process includes an alteration to the stencil.

Example 16 includes a non-transitory machine-readable medium including instructions that, when executed by a machine, cause the machine to perform the method of at least one of one of Examples 1-10.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method comprising:
receiving, by a trained generative adversarial network (GAN) generator and during a circuit board population process, an image;
generating, by the trained GAN generator, a synthetic x-ray image, the synthetic x-ray image is a prediction of a real x-ray image that will be generated by an x-ray inspection later in the circuit board population process;
determining, based on the synthetic x-ray image, whether the circuit board will pass or fail the circuit board population process; and
scrapping the circuit board or adjusting a parameter of the circuit board population process responsive to determining the circuit board will fail.

2. The method of claim 1, wherein:
the image is generated by a solder inspector after conductive material is situated on the circuit board by a screen printer; and
the image includes a view of the circuit board with the conductive material situated thereon.

3. The method of claim 2, wherein the determination of whether the circuit board will pass or fail occurs before the circuit board is provided to a pick and place of the circuit board population process.

4. The method of claim 1, wherein the image is of a stencil used in situating conductive material on the circuit board and by a screen printer.

5. The method of claim 4, wherein the adjustment to the parameter of the circuit board population process includes an alteration to the stencil.

6. The method of claim 1, further comprising receiving, with the image, image metadata, the image metadata including height of conductive material, volume of the conductive material, area covered by the conductive material, shape of the conductive material, a defect in the conductive material, a type of the conductive material, a source of the conductive material, a lot number of the circuit board, or machine settings of a screen printer or other machine used in the circuit board population process.

7. The method of claim 1, wherein the method includes scrapping the circuit board.

8. The method of claim 1, wherein the method includes adjusting a parameter of the circuit board population process responsive to determining the circuit will fail.

9. The method of claim 8, further comprising determining the parameter to adjust using a machine learning (ML) model.

10. The method of claim 9, wherein the ML model is a trained decision tree model, object classification model, object detection model, or feature classification model.

11. A system comprising:
a trained generative adversarial network (GAN) generator configured to:
receive, during a circuit board population process, an image; and
generate a synthetic x-ray image, the synthetic x-ray image is a prediction of a real x-ray image that will be generated by an x-ray inspection later in the circuit board population process;
processing circuitry configured to:
determine, based on the synthetic x-ray image, whether the circuit board will pass or fail the circuit board population process; and
cause the circuit board to be scrapped or adjust a parameter of the circuit board population process responsive to determining the circuit board will fail.

12. The system of claim 11, further comprising:
a solder inspector configured to generate the image after conductive material is situated on the circuit board by a screen printer; and
wherein the image includes a view of the circuit board with the conductive material situated thereon.

13. The system of claim 12, further comprising:
a pick and place device; and
wherein the determination of whether the circuit board will pass or fail occurs before the circuit board is provided to a pick and place of the circuit board population process.

14. The system of claim 11, wherein the image is of a stencil used in situating conductive material on the circuit board and by a screen printer.

15. The system of claim 14, wherein the adjustment to the parameter of the circuit board population process includes an alteration to the stencil.

16. A non-transitory machine-readable medium including instructions that, when executed by a machine, cause the machine to perform operations for circuit board quality analysis, the operations comprising:
receiving, by a trained generative adversarial network (GAN) generator and during a circuit board population process, an image;
generating, by the trained GAN generator, a synthetic x-ray image, the synthetic x-ray image is a prediction of a real x-ray image that will be generated by an x-ray inspection later in the circuit board population process;
determining, based on the synthetic x-ray image, whether the circuit board will pass or fail the circuit board population process; and
causing the circuit board to be scrapped or adjusting a parameter of the circuit board population process responsive to determining the circuit board will fail.

17. The non-transitory machine-readable medium of claim 16, wherein the operations further comprise receiving, with the image, image metadata, the image metadata including height of conductive material, volume of the conductive material, area covered by the conductive material, shape of the conductive material, a defect in the conductive material, a type of the conductive material, a source of the conductive material, a lot number of the circuit board, or machine settings of a screen printer or other machine used in the circuit board population process.

18. The non-transitory machine-readable medium of claim 16, wherein the operations include causing the circuit board to be scrapped.

19. The non-transitory machine-readable medium of claim 16, wherein the operations include adjusting a parameter of the circuit board population process responsive to determining the circuit will fail.

20. The non-transitory machine-readable medium of claim 19, wherein the operations further comprise determining the parameter to adjust using a machine learning (ML) model.
